(19) United States
(12) Patent Application Publication
(10) Pub. No.: US 2018/0084427 A1
(43) Pub. Date: Mar. 22, 2018

(54) SECURITY FEATURES IN NEXT GENERATION NETWORKS

(71) Applicant: ZTE Corporation, Shenzhen (CN)

(72) Inventor: David Huo, Newton, NJ (US)

(21) Appl. No.: 15/706,703

(22) Filed: Sep. 16, 2017

Related U.S. Application Data
(60) Provisional application No. 62/395,919, filed on Sep. 16, 2016.

(51) Int. Cl. H04W 12/08; H04W 12/06; H04W 12/04; H04L 29/06

(52) U.S. Cl. CPC H04W 12/08; H04W 12/06; H04W 12/04; H04L 63/0823; H04L 63/102; H04L 63/1441; H04L 63/20

(57) ABSTRACT

Techniques for improving functionality and robustness of the next generation 5G networks are provided. In one example aspect, a secure framework that takes into account the presence of multiple independently managed network slices and provides seamless interoperability is provided. In another aspect, techniques for improving tamper-proofing of a key-based identification framework are described.

### CROSS REFERENCE TO RELATED APPLICATIONS

This patent document claims the benefit of priority of U.S. Provisional Patent Application No. 62/395,919, filed on Sep. 16, 2016. The entire content of the before-mentioned patent application is incorporated by reference as part of the disclosure of this document.

### TECHNICAL FIELD

This document relates to systems, devices and techniques for wireless communications, including next generation network architecture.

### BACKGROUND

Efforts are currently underway to define next generation communication networks that provide greater deployment flexibility, support for a multitude of devices and services and different technologies for efficient bandwidth utilization.

### SUMMARY

This document describes technologies, among other things, for providing security to network communication and devices in the next generation (NextGen) network architecture.

In one example aspect, a network-side method of implementing an identity and slice management (ISM) function is disclosed. The method includes establishing communication with multiple network slice home subscriber servers (SHSS), communicating with multiple subscriber devices, establishing a communication interface with an identity center in the communication network, wherein the identity center holds information about subscriber identities and activities of the multiple network slices, and upon receiving a request from a new subscriber device, assigning an initial network slice to the new subscriber device.

In another example aspect, a network-side apparatus for operation in a communication network including network slices is provided. The apparatus includes: one or more memories storing code; and one or more processors that read the code from the one or more memories and implement an identity and slice management (ISM) function having established communication interfaces with the network slices, the code comprising: instructions for receiving an access request from a subscriber device; instructions for sending a security request to an IPC (Identity Provision Center) function to fetch identity related information on the subscriber device; instructions for receiving identity related information from the IPC; and instructions for initiating a key agreement (AKA) protocol exchange with the subscriber device.

In another example aspect, a method of providing unique identities to multiple entities in a next generation network is disclosed. The method includes maintaining a database that includes information about subscribe devices and network slices available in a communication network, receiving, from an identity and slice management (ISM) function an identity request message comprising credential information for a subscriber device, providing, to the ISM function, identity information for the subscriber device, and providing, to a home subscriber server of a serving network slice for the subscriber device, information to facilitate service offering by the serving network slice to the subscriber device.

In another example aspect, a security key derivation technique is disclosed. The technique includes generating an ephemeral root key using a static key and one or more secondary credentials; and generating a plurality of subordinate keys using the ephemeral root key, wherein at least one of the subordinate keys is used to provide services of a network slice to a subscriber device.

In yet another aspect, a method of accomplishing coordinated credentials security association on a user device is disclosed.

In yet another aspect, a technique for secure generation of a long term key is disclosed.

The details of one or more implementations are set forth in the accompanying attachments, the drawings, and the description below. Other features will be apparent from the description and drawings, and from the claims.

### BRIEF DESCRIPTION OF THE DRAWINGS

FIG. 1 is a flowchart showing an example method of implementing an identity and slice management function.

FIG. 2 is a flowchart showing an example method of providing uniquely identities to multiple entities in a next generation network.

FIG. 3 is a flowchart showing an example method of secure key derivation.

FIG. 4 is a block diagram showing an example of an apparatus used to implement a disclosed technique.

FIG. 5 shows exemplary network components in monolithic network infrastructure (left) and multi-business network infrastructure (right).

FIG. 6 shows exemplary architectures for identity holders.

FIG. 7 shows an exemplary infrastructure including an exemplary security layer.

FIG. 8 shows an exemplary diagram showing a generic ISM (Identity and Slice Management) environment and operations of identified exemplary entities.

FIG. 9 shows an exemplary diagram including an IPC (Identity Provision Center), an ISM and SL s in context of a VNF (Virtualized Network Function).

FIG. 10 shows an exemplary diagram including an IPC and an ISM in case of network slicing using VNF of two infrastructures.

FIG. 11 shows an exemplary diagram explaining a principle of integrating additional credentials into a key derivation.

FIG. 12 illustrates a concept of reusing of a current key derivation mechanism assisted by asymmetrical keys.

FIG. 13 shows security protection power of inclusive (left) and exclusive key derivation (right).

FIG. 14 shows a conceptual diagram explaining an approach for mitigating a security risk without burdening network resources.

FIG. 15 shows an exemplary relationships between network, device and subscriber

FIG. 16 shows exemplary security associations where user groups are defined by U1 and U2.

FIG. 17 shows a logical relations between SMM (security monitoring and management) function and other functions in NextGen infrastructure.

Like reference symbols in the various drawings indicate like elements.

### DETAILED DESCRIPTION

For the next generation 5G systems, architectures for new services and new devices are continually evolving. One feature offered by these architectures is to simultaneously connect through multiple interfaces for variety of radio technologies such as Wi-Fi, 4G, 5G sub 6 GHz and 5G high band or mmwave. Various industry standards organizations are in the process of specifying network architecture and device functionality for next generation networks (NextGen), which are expected to be deployed in near future and be used for many years thereafter. Therefore, it would be beneficial to specify and deploy techniques that are future-proof and meet the challenges not just in near term but many years down the road also.

It is expected that a NextGen architecture will use network slicing technology. In today's wireless networks, user equipment (UE) such as a mobile phone, a tablet or similar device, typically operate in a network managed and operated by a single service provider. As a result, today's 2G, 3G and 4G architectures are generally based on the assumption that device authorization and authentication procedure and associated functions such as home subscriber server (HSS) are managed by a single entity or at least are able to communicate with each other with well-established APIs.

In NextGen networks, such may not be the case. Each network slice may be operated by a separate business entity and may work with a different authentication/authorization protocol or algorithm. At the same time, with proliferation of mobile devices and services, there may be an increased need to secure device communication and integrity of the device platform. For example, NextGen UEs may operate in situations where there are multiple HSS (or AAA) that are managed by different operators with no currently defined ways by which these network functions can communicate with each other. A UE that is designed and built to operate in a particular operator's network may find itself in a location or situation in which the UE is either not recognized or not fully served by a network slice managed by another operator due to such protocol incompatibilities. In addition, with the proliferation of services and devices in the NextGen, and ever-increase level of sophistication of attacks, providing secure communication will become more and more important for longer term deployment and usability of NextGen architecture.

The techniques disclosed in this patent document can be used to provide solutions to, among other uses, the above-discussed challenges associated with the NextGen architecture and devices. Unless otherwise noted, the abbreviations and terms, e.g., access, core, radio, etc., used in the present description are consistent with their use in 3GPP documents, including the suite of documents released by the 3GPP 33 working group.

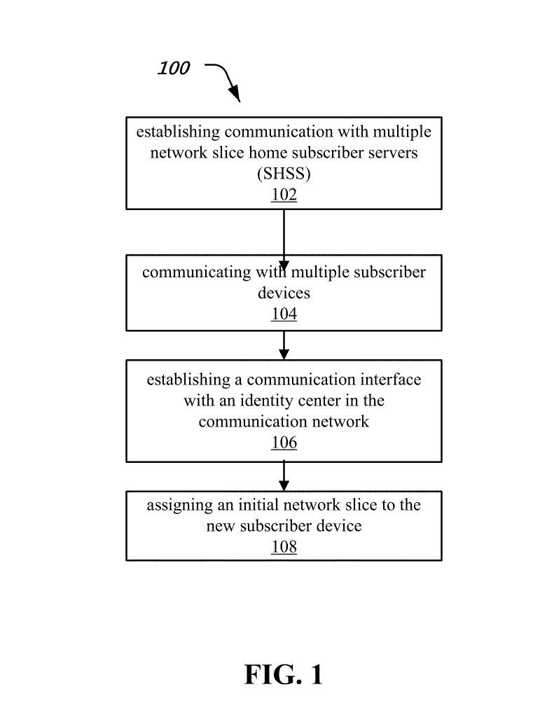

FIG. 1 shows a flowchart of an example network-side method 100 of implementing an identity and slice management (ISM) function. The method 100 includes establishing (102) communication with multiple network slice home subscriber servers (SHSS), communicating (104) with multiple subscriber devices, establishing (106) a communication interface with an identity center in the communication network, wherein the identity center holds information about subscriber identities and activities of the multiple network slices, and upon receiving a request from a new subscriber device, assigning (108) an initial network slice to the new subscriber device.

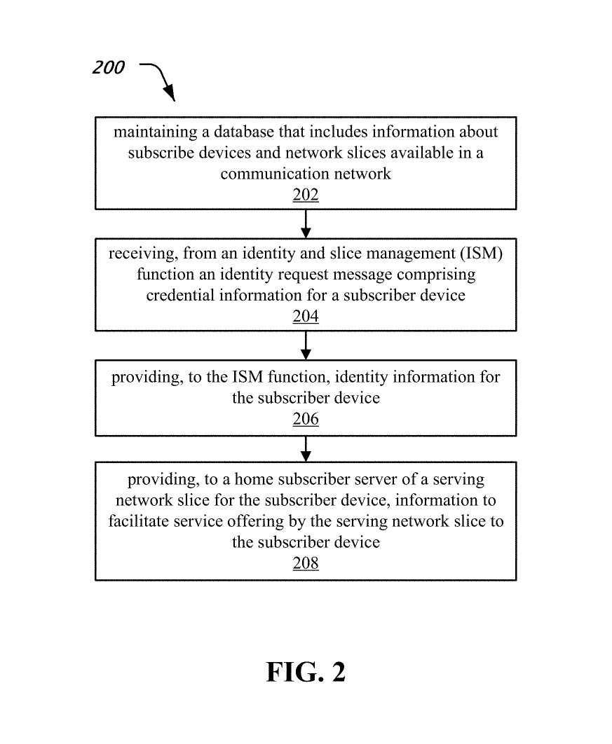

FIG. 2 shows a flowchart example of a method 200 of providing unique identities to multiple entities in a next generation network. The method 200 includes maintaining (202) a database that includes information about subscribe devices and network slices available in a communication network, receiving (204), from an identity and slice management (ISM) function an identity request message comprising credential information for a subscriber device, providing (206), to the ISM function, identity information for the subscriber device, and providing (208), to a home subscriber server of a serving network slice for the subscriber device, information to facilitate service offering by the serving network slice to the subscriber device.

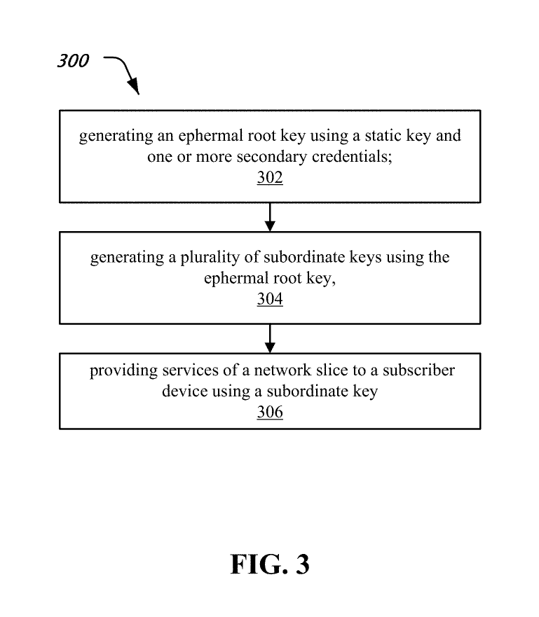

FIG. 3 shows a flowchart for an example method 300 for deriving and using a security key. The method 300 includes generating (302) an ephemeral root key using a static key and one or more secondary credentials, generating (304) a plurality of subordinate keys using the ephemeral root key, and providing network slice services (306), using at least one of the subordinate keys is to a subscriber device. Further features of the next generation architecture and framework are described in the attached claim set.

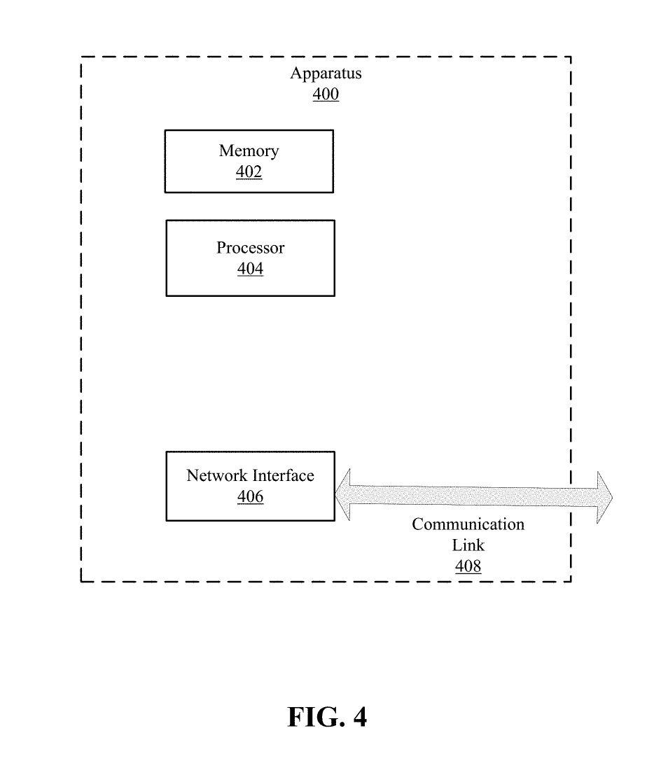

FIG. 4 is a block diagram showing an example apparatus 400 on which techniques described herein, e.g., methods 100, 200 or 300, can be implemented. The apparatus 400 includes one or more memories 402 that store processor-executable code and/or data, one or more processors 404 and a network interface 406 via which the apparatus 400 communicates via a communication link 408 with other entities in a communication network. Various technologies are known to one of skill in the art for implementing each of the memory 402, processors 404, network interfaces 406 and communication link 408 and are not listed here for brevity.

The following descriptions provide some examples of how the technology disclosed in the present patent document can be described as incremental changes to the existing 3GPP technical reports and specification documents. However, the specific discussion of changes to the current 3GPP draft documents is for illustrative purpose only and other embodiments and implementations are possible, as will be appreciated by one of skill in the art.

Monolithic and Multi-Business Network Deployments

Some examples of monolithic network deployments, typically found in today's networks, and multi-business network deployments that may be found in the next generation of networks are explained. The multi-business network deployment includes multiple network slices operated by multiple commercial entities.

Major goals of 5G include supporting the vertical business and flexible deployment (or tear-down) of diverse services. The concept introduced by NextGen to reach these goals is the network slicing. A slice consists of a group of network functions so that a complete telecom (traditional or advanced) service can be provided. The implication of this capability for the industry is revolutionary. While the telecom network today is often owned by a single operator, the future network infrastructure, thanks to the network slicing and other technological advancement, will be capable of supporting multiple ownership in a layered manner. This is a new paradigm of business model.

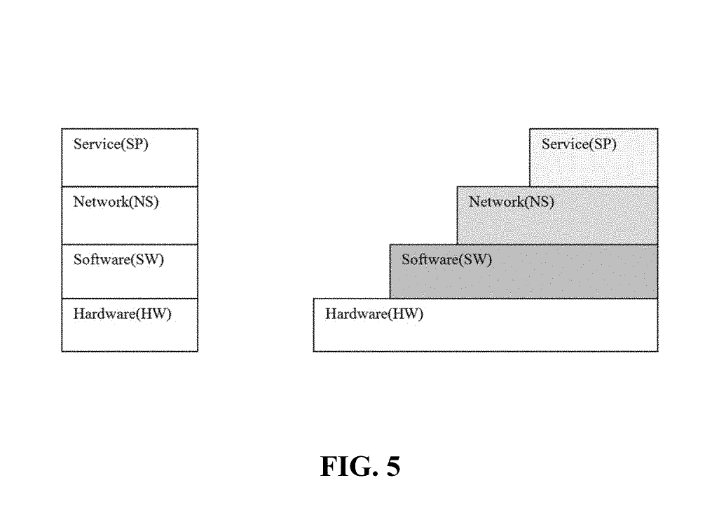

The enabler of this business model is the possibility of ownership of layers of a network infrastructure. FIG. 5 shows exemplary network components in monolithic (left) and multi-business (right) network infrastructures. The four layers (from bottom to top) include Hardware (HW), Software (SW), Network (NW or NS for slice), Service Provision (SP) that is capable of supporting vertical industry and flexible deployment. As mentioned above, the four layers in the monolithic network infrastructure are owned by a single operator, while the four layers in the multi-business network infrastructure are owned by different operators. Once the four layers are, as components, implemented and operated independently, the four components can be owned by different administrations, e.g. business owners. In total, 15 possibilities of ownerships are shown in Table 1, where “yes” means the owned part and blank means not owned by the same owner.

TABLE 1
Constellation of ownership in 5G.

| Case# | HW | SW | NW | SP | Comments |
|---|---|---|---|---|---|
| 1 | y | y | y | y | Today's Monolithic |
| 2 | y | y | y | | |
| 3 | y | y | | y | |
| 4 | y | y | | | |
| 5 | y | | y | y | |
| 6 | y | | y | | |
| 7 | y | | | y | |
| 8 | y | | | | |
| 9 | | y | y | y | NFV |
| 10 | | y | y | | NFV |
| 11 | | y | | y | NFV |
| 12 | | y | | | NFV |
| 13 | | | y | y | NFV |
| 14 | | | y | | NFV |
| 15 | | | | y | NMVO etc. |
| 16 | | | | | All Rental |

“y” indicates owning and
“blank” indicates not owning of the respective component.

Without loss of generality, it can be assumed that each lower layer entity can support multiple upper layer entities. The owner of a layer owns everything hosted by that layer: network elements, functions and customers. The ownership can be manifested by deeds, purchase contract, rental contract or SLA. Thus, an owner holds the identity and related private information about the subscriber, together with the software instance and equipments on the corresponding layer. Moreover, the relation of ownership is recursive from bottom to top.

The terms “ownership” and “identity” are two sides of the same coin: The owner owns the identities of a subscriber and software instances/hardware and is also obliged to keep the private information in this regard. In the following the “identity holder” and “owner” are used alternately. In some implementations, the need of identity management enters the NextGen within the context of “network slicing”, where a “network” supports multiple “slices,” each is capable of providing at least complete network service or vertical network services. An identity management will enable network slicing and help to manage the proliferated identities in the NextGen.

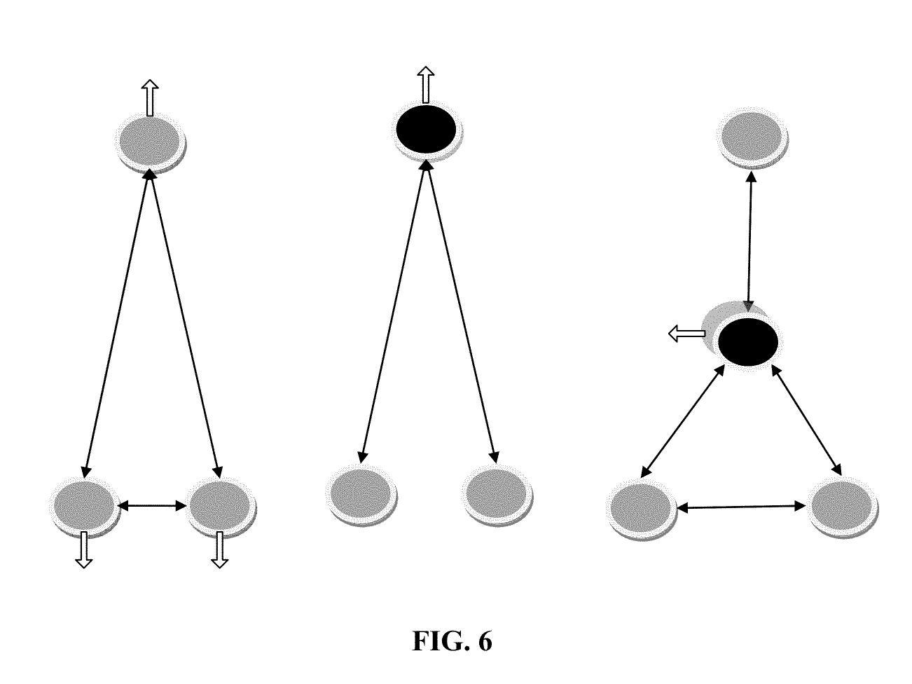

While identity management in LTE/EPC deals with customer credentials in terms of privacy and secure communication, the identity issue in NextGen has a broader scope. It deals with subscriber identities of different trust domains within the same network. Any approach would try to minimize the impact on service experience, while reusing of the established procedures and components. For instance, an identity can belong to a network slice that is hosted by another operator who hosts more than one slices or none. As identity we refer primarily to the subscriber identity, but including also identity of the network function instance, network slice instance, user devices or even services. A feasible authentication mechanism relies on a feasible identity definition and management architecture. FIG. 6 shows possible architectures for three identity holders: Flat (left), Hierarchy (middle) and Agent (right). The bold thicker arrows indicate interaction with HSS (Anchor) and UE. In the Agent architecture (right), the two overlapped shapes refer to distinguished identity holders. The management architecture can have at least one, or a combination, of the followings:

1. Architecture 1: Flat distribution as in FIG. 6 (left): Each identity holder acts in coordination with other equal identity holders during authentication and authorization. Information is exchanged between them in a secure manner. The actual information to be exchanged, the protocol to be used and the procedure involved will be determined such that the secrecy is maintained for each identity holder during operation.

2. Architecture 2: Hierarchical as in FIG. 6 (middle): One identity holder possesses more information of, and works on behalf of, other identity holders. The information division between the hierarchies may be specified depending on ownership constellation and the identity holder of the higher hierarchy could be implemented as a proxy of the identity holders of the lower hierarchy. This may apply when CN and RN are not on the same slice, or when a primary MNO owns the entire infrastructure and it rents some slices to a tenant, i.e. a secondary MNO. The line between Architecture 1 and Architecture 2 can be obscured when function is split between different identity holders to facilitate operation in certain scenarios.

3. Architecture 3: Identity Agent as in FIG. 6 (right): A third party works on behalf of all identity holders to handle the identities related communication and operation. It needs secure association with each identity holder, obfuscation of data transfer and it takes part in the authentication and authorization of subscribers. An agent acts like an identity provider, but the confidential information about the subscribers are still under the jurisdiction of individual MNOs. It is deemed generic, as it may well include Architecture 1 and Architecture 2 through collocation, thus reducing interfaces.

Both centralized or distributed identity management (IM) have pros and cons. For example, the centralized IM is more feasible of being placed in physical secure location but may be not very scalable although this is an issue only for large number of nodes. The distributed IM is more capable of adapting to changed identity ownership relation and physical network change but has cost and potential security risk due to number of interfaces.

In some implementations, Architecture 3 can serve as the generic architecture, while the other two the implementation variants.

LTE/EPC is a monolithic system, where the infrastructure and major services are operated and administrated by a single authority. This condition is no more valid in the future network, when trust boundaries will present within the same (physical) infrastructure. The security architecture needs to adapt itself to this new environment.

What used to be single HSS can now be shared by multiple identity holders, possibly of different trust domains, within the same infrastructure, i.e. (HW,SW,NW,SP). Different designs may have different security risks, such as user information loss, impersonation, DoS and negative impact on performance etc. In case of network slicing, a network slice (NS) and the network infrastructure hosting the slice may have a different subscriber identity holders, as they are owned by different businesses. The feasibility and scalability of an architecture may well depends on whether CN, RN or CN&RN are completely sliced or partially or not at all. To support the architecture, the following items could be implemented: defining identity holder function for secure handling user, device and network information, providing interfaces from the identity management to other network entities in an appropriate architecture, potential reuse of existing identity management techniques (GBA, OpenID, etc.) or components, and/or evaluation of architecture design against feasibility, security and scalability.

Architecture for Identify and Slice Management

While a slice is a fully operational service provisioning network in the traditional sense, a NextGen entertaining multiple slice may need additional mechanism to enable the security provisioning to the subscriber on the one hand and real-time slice association on the other hand. An architecture that introduced several new functional blocks that can be used to manage identities of devices as devices move among multiple network slices and necessary architectural components are explained. A function called IDC (identity center) is the holder of identities of subscriber, slice instances, devices, PKI, etc. Another function called Slice HSS (SHSS) acts as a local holder and manager of credentials. Yet another function called Identity and slice manager (ISM) coordinates the operation of other entities and assist in managing the lifecycle of both service and slice.

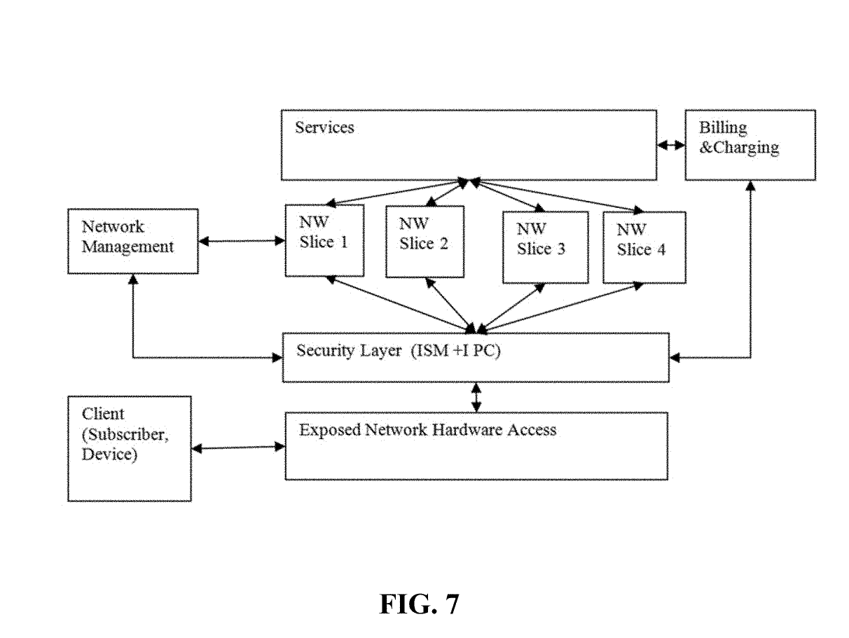

Network slicing introduces new challenge in provisioning security, starting with authentication and authorization, as different trust domains may exist in the same infrastructure. Potential issues include: maintaining (or improving) the experience of service (EoS) for the mobile users, allowing isolation and operation of slices, assuring future evolution of the telecom infrastructure, reusing or adapting the existing technologies. Due to the potential complication of the trust domains within the infrastructure, caused by the new business models and network technologies (22.981), network slicing needs an additional layer between slices and infrastructure, to handle, or assist authentication and authorization of subscribers and devices, as well as maintaining network slices. The additional layer is tentatively referred to as the security layer comprising an identity and slice manager (ISM) and an identity provision center(IPC), as illustrated in FIG. 7.

The security layer operates to perform the following: authentication of the subscriber identity and the related device identity, authorization of the identified subscriber the access to the desired network function, isolation between slices in cooperation with MANO (NMS in case of non-NFV), assist in key material management for subscribers and for interacting slices, policy management and enforcement for services as well as network functions, providing BSF, directly or indirectly, or delegate/coordinate slice specific BSFs, inter-working between network infrastructures as well between slices, e.g. AKA between ISM and NS instance, in situation of service update and restoration etc.

In this regard, six exemplary entities including a device, a subscriber, an identity provision center (IPC), a network slice (NS), a slice HSS (SHSS), and an identity and slice manager (ISM) can be identified. For example, the device may contain credentials and service related information about the subscriber. The subscriber may have registered identity by IDP and can be associated with multiple devices, slices and services. Terms such as client or UE can be also used to include a device and a subscriber. The IPC operates as a holder of identities of subscriber, slice instances, devices, etc. The IPC includes a database that maintains and manages the relation between the entities in reference to the subscriber identity, as well as the individual policies and service attributes. The NS may contain at least one network functions, each is capable of complete specific network operation. The NS may be configured as a telecom or verticals. The SHSS operates as a local holder and manager of subscriber credentials and service attributes. The ISM may coordinate with IPC and MANO, in case of NFV, or simply NMS, to facilitate the authentication, authorization and lifecycle management of security related entities and operation that are useful for the subscriber to have service on the adequate slices (ISM).

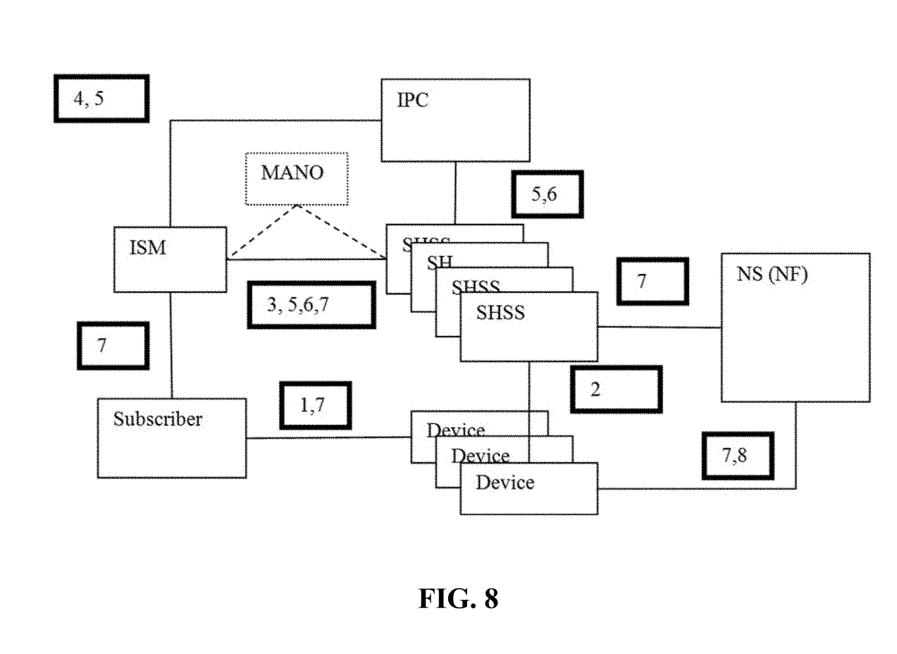

Identity management, authentication and authorization within the security architecture of NextGen is the enabler of a consistent security in NextGen. FIG. 8 illustrates an exemplary diagram showing a generic ISM environment and operations of identified exemplary entities. The identified entities work together to facilitate the authentication, authorization and security operation. The generic sequence of the operation can be listed roughly as following:

Operation 0. The subscriber credential is pre-shared between IPC and Client (subscriber, device, etc.). Slice specific service and policy information may be shared between SHSS and the client.(Alternative constellations will be discussed later).

Operation 1. Subscriber initiates access, through physical, manual or automatic means, on the device.

Operation 2. Device sets up temporary access with the SHSS of a default NS, (e.g. client-server request, possibly with a preliminary AKA to assure trust between the device and the default slice).

Operation 3. The SHSS of the default NS requests an authentication and authorization by ISM. (Alternatively, the default NS can switch the requests directly to the ISM).

Operation 4. ISM has a secure connection with IPC, so that it sends request to IPC to fetch the identity related credentials. It also provides keys (or certificates) for establishing secure connections between IPC and SHSS.

Operation 5. Secure association (channels) on interface SHSS-ISM, as well as on interface IPC-SHSS, is established by means of appropriate crypto procedures.

Operation 6. IPC transports the identity related information to ISM necessary for the authentication an authorization.

Operation 7. ISM (or SHSS) initiates an AKA with the subscriber, through NS (security anchor) and device (UE&UICC), followed by (or after) authorization, that places all needed ephemeral keys and security materials in the designated NS. Alternatively the attachment request can be rejected, as part of the protocols.

Operation 8. Serving NS starts to deliver services to the subscriber's device.

The functional blocs ISM, IPC and SHSS shown here are of abstract nature. The implemented architecture may allow merging any two or all three, depending on the deployment reality. For a single slice, which is equivalent to the incumbent telecom operator, all three are united into the HSS including AAA. In other deployments, the architecture may be influenced by the information in IPC and SHSS, that can have three possible situations:

Mode 1: All subscriber information are in IPC. SHSS has only slice specific copies.

Mode 2: Subscriber information is shared between IPC and SHSS, depending on general or slice specific, short term or long term, trust, service, etc.

Mode 3: All subscriber information are in SHSS. IPC holds a (obfuscated) copy on lease.

The decision on which of the above mode is taken has direct impact on the procedure of authentication and authorization. A model adaptive design may be considered for a possible approach.

Both IPC and ISM use information about the slices, but in different ways. IPC is a data base and maintains relation between the subscriber identity, device identity, slice identity etc. ISM obtains more information about the slice from MANO and is responsible for secure communication between IPC and SHSS, as well among SHSSs. In some cases, it can be part of the subscriber AKA process, e.g. when it acts as proxy of a SHSS.

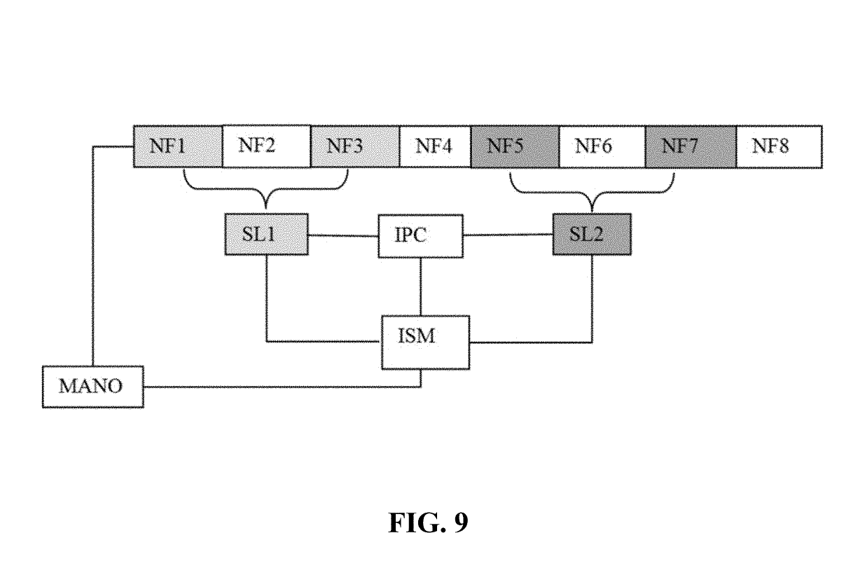

In case of NFV is deployed, FIG. 8 can be better understood, when being seen from the network perspective, i.e. in a third dimension. A need to see the architecture from this perspective is also motivated by 22.891-300 (Section 5.2.1) where it is stressed that network slicing should be possibly implemented by virtualized network functions (VNF). For the purpose of better understanding, the details of NS+SHSS+Device+Subscriber of a slice is ignored for the time being, such that they are represented by a single block SL in FIG. 9, which shows the (virtual) network functions in the same infrastructure and their relation to the slices, the IPC, the ISM and the MANO. In FIG. 9, the IPC, the ISM, and SLs are shown in context of the VNF, where 2 slices, SL1 and SL3, are assembled. SL1 includes NF1 and NF3. SL2 includes NF5 and NF7. All NFs are from the same infrastructure.

A network within a trust domain may consist of multiple slices. Assuming IPC-ISM connection is a stable internal secure connection. However, the connection between ISM and each slice may need more frequent update due to the dynamics of the slice instance. Therefore, one of the tasks of ISM is to establish secure communication between each slice and IPC, as well as between ISM and each slices. Assume the network has N slices. The secure connections to be established and maintained are N for ISM-SL and N(N−1)/2 between slices. This fact may be useful for the selection and design of the protocols and procedures for the establishment of the secure connections, as well as the authentication procedure. In front of this background, there are pros and cons for using methods based on symmetric key or asymmetric key.

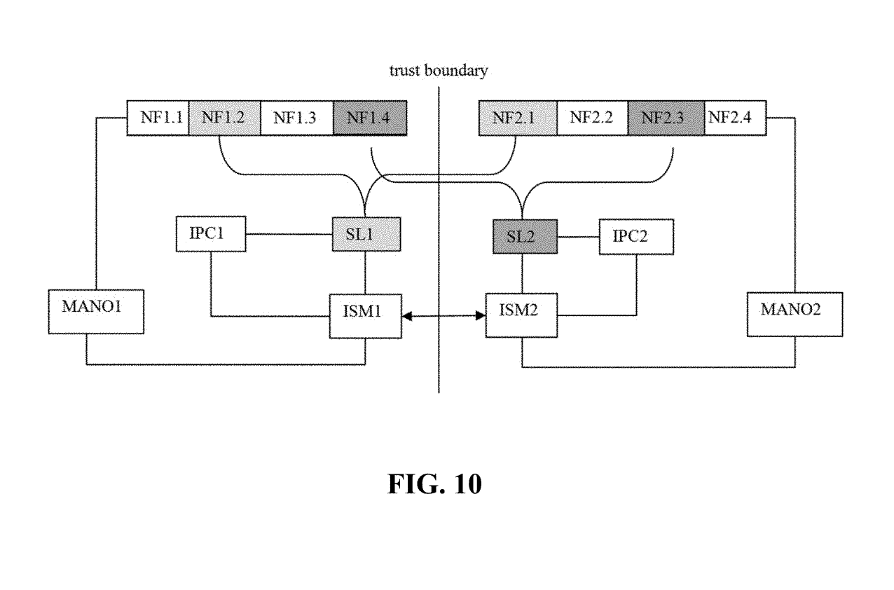

One of the requirements by 22.891 goes even one step further (Section 5.2.1) in asking for the possibility that a slice be assembled using network functions of different infrastructures (i.e. from network infrastructure operators). This situation is shown in FIG. 10, where two slices, each is based on NFs of two independent infrastructure is shown. FIG. 10 shows an IPC and an ISM in case of network slicing using VNF of two infrastructures, where only two such slices, i.e. SL1 and SL2, are shown. SL1 includes two network functions from two different infrastructures (blue and green) and so is SL2.

For this scenario, a secure channel needs to be established between ISM1 and ISM2, so that ISM also has the function of secure gateway during the attachment and perhaps also during the connection to maintain the subscriber and slice relation. Hence, the link ISM1-ISM2 can be a secure tunnel with quasi-permanent nature, but can also be established and tore down for each subscriber connection. There is a trade-off between the cost (including performance) and the deployment flexibility (saving for operator). The security technology used for this connection is to chosen based on analysis of such trade-offs.

While the discussion here attempts to give an architectural design on the authentication and authorization framework in NextGen, that takes into account the network slice in particular, it needs to consider the current work of AKA in SA3. The similarity, as well as differences, of building blocks defined here and there are noted as following:

IPC vs. ARP (Authentication Credential Repository and Processing Function): IPC is more a repository and the processing function consists primarily of building, maintaining and repairing the data base.

ISM vs. AUS (Authentication Server Function): ISM primarily is a facilitator for AUS when AUS is on SHSS. ISM can take over AUS in some scenario to improve the performance and reduce cost.

SHSS vs. SEA (Security Anchor Function): SHSS may need to be SEA for each slice, unless there is function split between slice and ISM, e.g. between authentication and authorization, or between two authentications.

To support the architecture suggested, the following items may need to be considered: functionality allocations/distributions in ISM, IPC and SHSS, security interfaces within the security layer and with other parts of the network, adequate procedures and protocols, taking into account the interworking with pre-5G, authentication and authorization procedure in this environment, and/or security procedures of interworking between infrastructures (network operators trust domains)

Multi-Credential Key Derivation

Techniques are discussed for deriving an encryption key that can be used as a long term key to provide a robust identity for a device, UE or some other underlying network entity being protected by the key. In today's networks, a subscriber device's identity is often represented by a long term key which does not change over the lifetime of the subscriber device. The long term key is, however, not directly used for any ongoing transactions or services, but is used to derive a session key which may be used by services in the network. For example, a banking application being executed on a subscriber device may bootstrap the long term key using a certificate-based protocol to derive a working key during a financial transaction. In the next generation architecture, such a framework may have some operational disadvantages. For example, certificate-based key derivation may cause delays in transactions that may negatively impact user experience. Furthermore, such transactions might waste network bandwidth and airtime. In addition, continuous exposure of messages over public network may tend to increase the probability of the long term key itself being compromised.

In one advantageous aspect, the techniques provided herein could be used to mitigate such operational shortcomings. For example, in some embodiments, the long term key may be derived such that it is not tied to a single credential, but may be a key that is derived by using one or more other credentials. Key derivation using additional credentials, which has been proposed, has the advantage of improving security, while maximizing reuse of established AKA key derivation methodology, hence minimizing the impact on performance.

Making use of third party credentials for service provisioning is already established by the effective GBA procedure in the LTE/EPC and before. It is based on using a single root credential to enable additional credentials under the protection of security certificates. NextGen is expected to face even harder security challenge and expected to deal with even more credentials. One of the popular approach proposed in this respect is to switch to a fully certificate based key generation scheme, based on Diffie-Hellman (DH). Knowing that DH would consume much more resource than the current symmetrical key generation scheme and the issue of managing PKI within an already quite complex trust environment of NextGen, it does not seem prudent to deploy DH for every key needed for the network operation. In order to preserve the good experience and solutions developed in 3GPP, it seems reasonable to design the new mechanism of key generation/derivation in such a way, that DH is only used, when it is really needed, while the old key derivation method being reused as much as possible.

Due to the extension of service diversity and flexible network functionality envisioned by NextGen, a need for alternative credentials, in addition to the shared long term keys, becomes apparent. The alternative credential is considered a supplement, rather than a replacement, of the well-established AKA procedure in 3GPP. Besides known methods of provisioning alternative credentials using the root key, the root key can also benefit from additional credentials, if the following questions can be answered:

1. Shall the additional credential cooperate with the exiting symmetrical key derivation method?
a. A cooperation would harden the protection of root credentials and would add more flexibility in provisioning of security services. It may require some change to the current key derivation scheme.

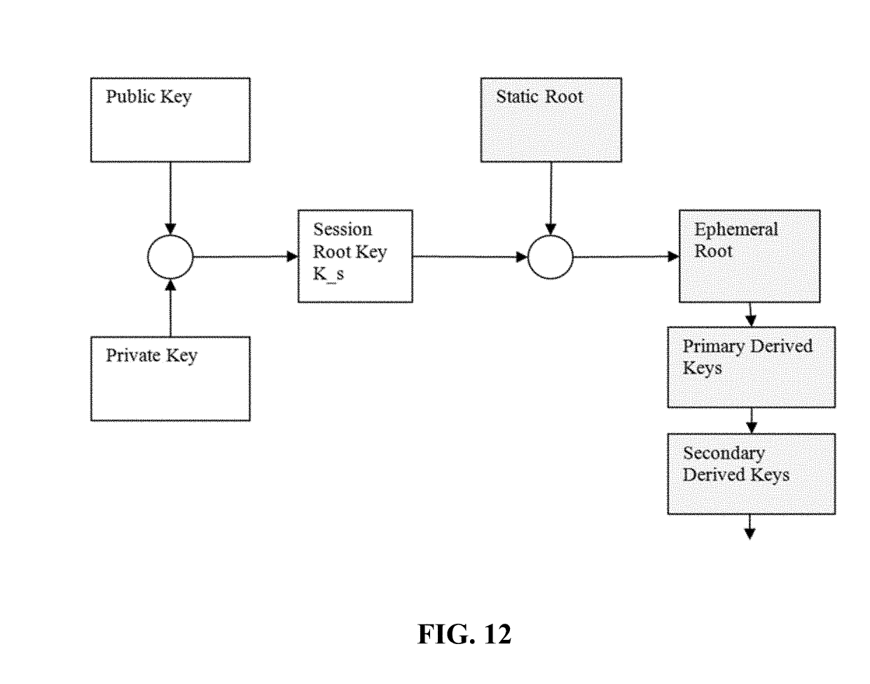

2. Assuming the last question is answered with yes, on which level shall the interworking take place?
a. From the efficiency point of view, the higher in protocol layer, the better. Since if ephemeral root key (cf. KASME) is derived based on the long term key together with the alternative credential, then the majority of the legacy procedures could be reused or minimally impacted. One of such design is illustrated in FIG. 12. From resource usage point of view, the lower in the network layer, the more resource could be needed for provisioning.

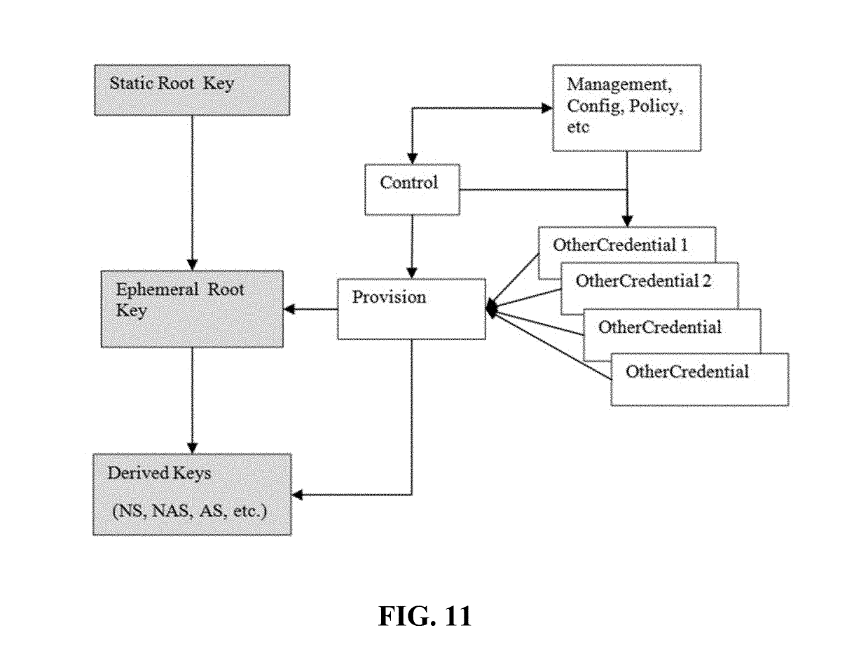

FIG. 11 shows a diagram explaining a principle of integrating additional credentials into a key derivation. Some implementations for acquiring the Ephemeral Root Key includes letting K be the static key and K_S be the key derived from some secondary credentials. Integration of asymmetrical secondary credential into the ephemeral root key can be proceeded as following:

i. Run a public-key based AKA to determine a session key K_s (alternative session root key).

ii. K_s and K are used to derive the ephemeral root key.

iii. Ephemeral root key is then used to derive all other subordinate keys, e.g. slice keys, NAS keys, AS keys, etc.

This may have minimal impact on AKA being used. Despite the possibility of incorporating additional credentials, the static root key K_s can still be used stand-alone, to allow for more flexibility for key generation. FIG. 12 illustrates a concept of reusing of a current key derivation mechanism assisted by asymmetrical keys.

With increasing criminal capability of attackers, any improvement to the current key derivation to raise the level of protection for the subscribers and service would be precious. It benefits localization of damage caused by key leakage, as explained in [RFC 5448]. The possible implementations may include a method of provisioning additional credentials (adapted and modified GBA, OpenID or 33.924 etc.) and/or a method of integration of additional credential into the key derivation, while maximizing the reuse of the existing structure and mechanism.

Minimum Root Credential Set for AKA

A minimum credential set that can be used to provide a unique, robust identity is explained. With respect to communication and device security, in the next generation networks, four stakeholders or actors may interplay with each other. These include a device manufacturer, a network operator, a subscriber and a subscriber device. Each of these actors may have the opportunity, or at least may want the opportunity, to control a portion of the security or encryption framework. In some embodiments, one or more of these four entities may provide unique identifications such as keys or certificates, which may be merged together to produce a basis for offering security in device communication or access to services.

As NextGen will be dealing with multiple devices and services, more credentials will be integrated in the security framework of NextGen design. In order to assure mobility and inter-operability, a minimum set of default credentials is necessary. The following is a proposal, taking into the different roles active in the communication of the network, to initiate further discussions.

Beside the identity of subscribers, the devices will become more important because of the new applications introduced, not only for the telecom service users, but also for vertical users. In addition, the network is further split into slices so that each slice can operate independently like full blown traditional network, capable of providing different novel services. In order to be prepared for this new environment of operation, a network (infrastructure) needs to maintain and use diverse identities in an orchestrated manner to facilitate the operation and the associated authentication and authorization:

1. Mutual authentication and authorization between Subscriber and network slices.

2. Mutual authentication and authorization between Device and subscriber.

3. Mutual authentication and authorization between Slice and infrastructure.

4. Mutual authentication and authorization between Slice and slice.

A slice includes at least one (virtual) network function. Hence, just like all virtual network function, a slice enters the operation as a dynamic software instance. ETSI-NFV has clear specification regarding the attestation procedures regarding VMs and VNFs, but network slice is not part of NFV's responsibility, because it is viewed as an application built on top of VNFs. Therefore, the management of the network slices should become part of the security architecture of NextGen.

For this purpose, a set of root credentials are defined and maintained, from which keys can be derived from credentials of all major players in the network operation, i.e., manufacturer, operator, subscriber devices. A basic set of static root keys can be considered as a Basic Triplet: (K, Mp, Op).
Device: Asymmetrical key pair, Mp-Pair=(Mpr, Mpu), provided by manufacturer, where the private key Mpr is located at device and public key Mpu at HSS.

During any communication there is at least one device involved, hence at least one device credential is present. Since a basic triplet holds only one device credential, a representative device can be selected to provide credential in the basic triplet, other devices are associated with this credential. Alternatively, group of devices can be defined and a group key is used, so that the individual device is credential is deployed only when needed.
Network (Slice): Asymmetrical key pair, Op-Pair=(Opr,Opu), provided by operator, where the public key Opu is located at the device (or specific module) and the private key Mpr at HSS.

Certificate CA_M for Mp-Pair and CA_O for Op-Pair may be needed to facilitate the provisioning. The manufacturer certificate CA_M is to vouch for the authenticity of the device. The operator certificate CA_O is to vouch for the authenticity of the network (or slice). This key pair will be used for mutual authentication between slices and between slices and infrastructure, as initiation shared secrecy to derive session keys based on some AKA to be developed yet.
Subscriber: The long term symmetrical key for the subscriber remains the most crucial part of the entire security framework and, as such, never leaves HSS.

The three root keys in the basic triplet can be used to derive secondary keys, either independently or cooperatively, through appropriate key derivation functions. As result, there are 6 categories of secondary derived keys, as shown in Table 2 below.

TABLE 2
Categories of derived keys

| Category | Origin of Derived Keys | Comments |
|---|---|---|
| 1 | K | Subscriber root credential |
| 2 | Mp | Device root credential |
| 3 | Op | Network (slice) root credential |
| 4 | K, Mp | Subscriber and device |
| 5 | K, Op | Subscriber and network(slice) |
| 6 | Mp, Op | Device and network(slice) |
| 7 | K, Mp, Op | All |

Having more credentials available for a single subscriber assures consistent operation of NextGen, including network slices and devices. The benefits also include flexible security procedure capable of supporting different security aspects of NextGen and secure deployment of massive devices, using partial credentials. Also, compromised long term symmetrical key does not have to mean eavesdropping.

The possible work items include an integration of the minimum set into AKA protocols, so that a selection of subset is possible, key derivation and update procedures, so that change of subset is possible, and/or provision method that takes into account possible diverse locations of the credentials in the set.

Service Isolation by Credentials

Examples of coordinated deployment of credentials are discussed. Integrating multiple credentials into the core security process of NextGen does not only increase the hardness of the security, but also enable more flexibility in providing quantized protection, based on trade-off between protection power and resource/time consumption and the service requirement (e.g. latency), depending on applications. One advantageous aspect is that if a particular credential gets compromised, only a subset of devices and/or services, but not all devices and services, may get compromised.

Assume that multiple credentials are introduced in the core security process in NextGen. Then, the multiple credentials needs to be used and managed so that not only the security provisioning but also the service provisioning can benefit. The following descriptions propose an application of quantized deployment of multiple credentials.

Current keys used in LTE/EPC are derived from a single root key that is associated with a subscriber (IMSI). The daily operation uses only keys derived from the root. The frequency of usage depends on the key hierarchy. As all the derived keys originated from the same root, all of them contain the same amount of secrecy, albeit more entropies due to seeds and salts. Services provided by a third party can bootstrap its own credential using this root key. Theoretically, an attacker who has possession of the root key, he can get access to the services passively or actively, causing damage to legitimate users. On the other hand, different applications and operations may require different levels of protections, simply due to the trade-off between feasibility and resource consumption. To this end, a quantitative provisioning of security service can be considered, when credentials are used according to needs. A credential level (of a key) can be defined as a monotone increasing function of the amount of independent credentials contained in the key.

Let S_i be mutual independent credentials (knowledge). For each S_i a key K_i , where i=1,2, . . . n., can be generated by a single variable function, such that:

K_i=F_i(S_i) for i=1,2, . . . n

An attacker who captured K_i can at most retrieve the secret knowledge S_i. This way of key generation is “exclusive,” as each key K_i is associated with a different credential S_i, independently. Note that there is a subscriber identity root credential that has to be used in generating any key, an exclusive key generation is in fact based on a single function and a single credential only, which limits its flexibility in application.

An “inclusive” key generation is expressed by a multi-variable function:

K_i=F(S_1,S_2, . . . S_i) for i=1,2, . . . n,

Each key is generated with a unique subset of credentials.

An attacker who captured K_i can recover S_1, . . . S_i at most. In addition, if an application depends on one subset (S_1,S_2, . . . S_i) only, then only key K_i is needed. Note that, depending on the selection of subset, all K_i can still share at least one credential in common (root key), we are able to generate keys with different functions that are partially dependent on a single credential. It is possible to define a partial order. Hence, the “inclusive” key generation allows for a natural key hierarchy:

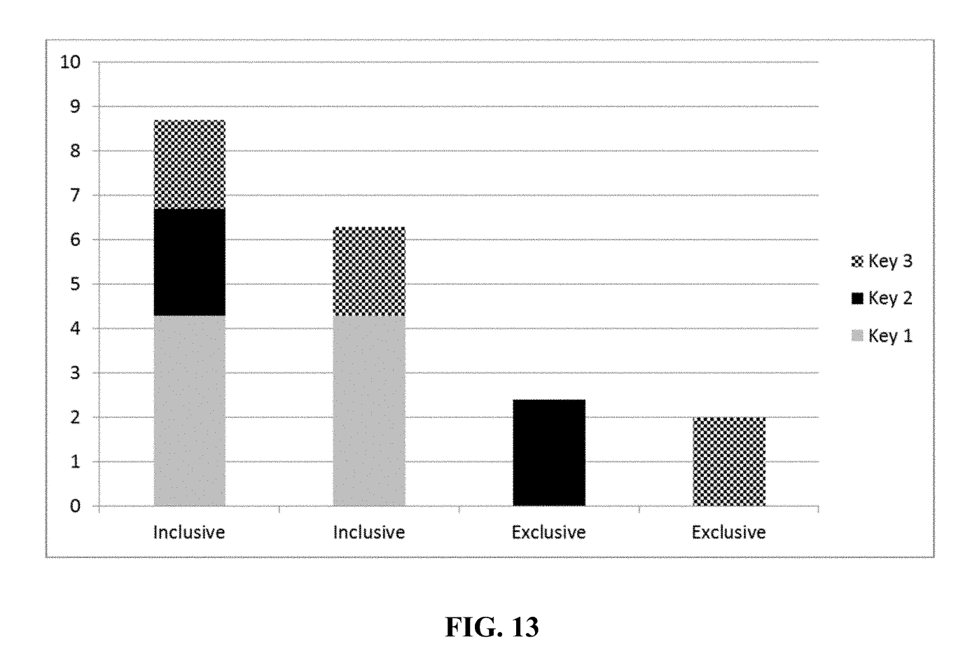

K_1, K_2, . . . , K_n

where differently derived keys have different credential contents. This property can be exploited for service provisioning. Assuming not all service requires protection by identical credentials, different K_i can apply to different services, achieving a trade-off between security and performance. Difference between inclusive and exclusive key generation can be illustrated in FIG. 13. FIG. 13 shows security protection power of inclusive (left) and exclusive key derivation (right). The inclusive key derivation includes differently derived keys and the exclusive key derivation includes a single key. The security function in a network can acquire additional flexibility by the inclusive key generation, facilitating introduction of new services, as illustrated by example in Table 3.

TABLE 3
Example for credentials inclusively associated with derived keys.
Example contains 4 independent credentials and 7 credential levels.

| Cred Level | | | | | | | |
|---|---|---|---|---|---|---|---|
| (right), | | | | | | | |
| Credentials | | | | | | | |
| (below) | 1 | 2 | 3 | 4 | 5 | 6 | 7 |
| 1^{st} | S1 | S1 | S1 | S1 | | | |
| 2^{nd} | S2 | S2 | S2 | | S2 | | |
| 3^{rd} | S3 | S3 | | S3 | | S3 | |
| 4^{th} | S4 | | | | S4 | S4 | S4 |
| . . . | | | | | | | |
| Key = F (right) | S1-4 | S1-3 | S1-2 | S2, S3 | S2, S4 | S3, S4 | S4 |
| Application | NAS | AS | MEC | Autom | IoT | mIoT | Etc. |
| (e.g) | | | | | | | |

Assume among the four credentials, S1 is the subscriber static root and others are related to device types. When a service is associated with a given type of device that requires only credential S4, the service can be activated and protected by key F (S4). A compromised key can at most reveal the credential S4, but not other credentials and, thus, poses no danger to other services and the network. To provide implementations of a multiple credentials deployment, a credential level according to the algorithm strength and application is defined and the credential level in key generation and key deployment design is applied. Related provision, storage and lifecycle management issues are considered as well.

Knowledge Split for Longer Term Root Key

Embodiments are discussed, in which device identification keys are split into multiple parts, with some of the parts being controlled and specified by different actors in a wireless network. The actors may include, the user, a service provider, a UE manufacturer, and so on. In some embodiments, the keys derived according to the procedures described in Appendix F may be used to secure the communication described in Appendix B (between ISM, IDC, SHHS and subscriber devices).

In 3GPP architectures, all keys are derived by the same static root keys that is kept within HSS and UICC. A compromise of this key would have disastrous consequence. Such a scenario is described in 33.899. To mitigate the increased security risk, such as eavesdropping, caused by the loss of long term key, solutions are proposed in 33.899, making use of either additional credentials and additional protocols on line. The solutions, however, cause two issues that the increased resource consumption, in particular, of expensive radio resource is required and that the reasons of the long term key loss as given in KI2.2, which lies out of the scope of the communication infrastructure is not addressed.

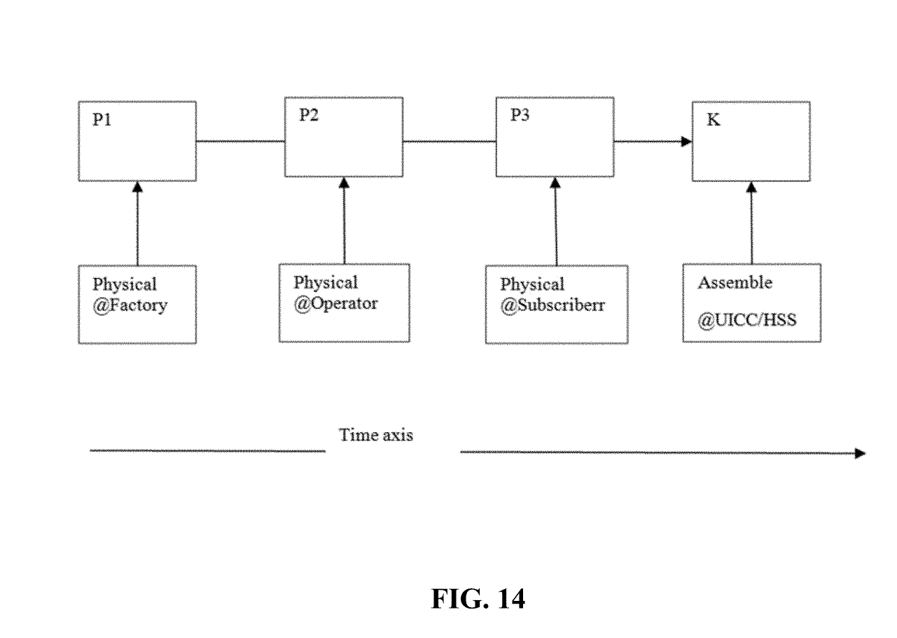

As is typical for security, the defense can include being better placed where the cause lies, rather than where the consequence occurs. An approach to the same problem without burdening the network resource is suggested in the below and illustrated in FIG. 14:

1. The knowledge of the long term key K be split into multiple pieces, e.g. P1,P2,P3.

2. A mathematical function F is defined that allows derivation of K from (P1,P2,P3), i.e. K=F(P1,P2,P3). An example is the concatenation K=P1∥P2∥P3.

3. The provision of P1 be made by the manufacturer into UICC in the factory.

4. The provision of P2 be fed into UICC by the operator during the contract signing with the subscriber via an independent secure means and signed by operator representatives.

The provision of P3 be made into UICC by the subscriber through key pad and can be changed via a password or other secure mechanism (e.g. biometric) on the device later over an appropriate protocol in HSS.

Different parts of the keys are initiated at the different time points and possibly also different locations, to assure increased difficulty for any attacker to get possession of the entire key through illegal means as given in KI2.2 All key parts can be provisioned by GBA procedure off-line, e.g. step by step, to let P1 initiate P2 and P1+P2 initiate P3. The following are two example for serial and parallel combinations.

### Example 1

P1 with full length of K is generated at first. Using P1 to bootstrap another key and truncate it to size P2 and fill into the part in K reserved for P2. Finally, using the updated key P1|P2 to bootstrap another key P3 and truncate it to the size of P3 and fill into the part in K reserved for P3.

### Example 2

P1 with full length of K is generated at first. Using P1 to bootstrap another key P2 of the full length of K and combine P1 and P2 by a function P2′=f_1(P1,P2) to generate a new key. Using this new key to bootstrap a third key P3 of the full length of K and combine P3 and P2′ through a second function to obtain the final K=f_2(P2′,P3).

The method and time of the provision of the three pieces are crucial for the quality of the resulting key. The spatial division of the provisioning can be assured by separate and independent channels and procedures, while the temporal division can be implemented by means of a token that is passed from one step to another until being destroyed by the last steps. Assembling the key K from parts can be achieved through a merge be either serially or parallel. There are certainly many possible ways to make it adequate for the purpose. Some implementations may provide secure methods for key parts provision, assurance of independent provision channels, and/or standardized procedure.

Data Structure of Security Association

Key management is discussed, in which the use of network airtime is minimized. Security association and its definition is part of identity management and security provisioning. The present contribution addresses the issue by identifying the relations between network slice, device and subscriber from security perspective. In some embodiments, keys associated with network entities such as devices may be logically grouped using multiple associations. This type of association takes into account future deployments in which a device may be shared by multiple subscribers and a single subscriber may use multiple devices. Similarly, a single subscriber may belong to different network slices at one time, or at different times. Thus, a security association may be formed based on one or more of these properties; device-slice tuple or device-subscriber tuple or device-subscriber-slice triplet, and so on. The configuration set that lists these associations may be unique for a given device and may be maintained both on the network-side and on the device-side. For security and authentication purpose, service or use disruption can be minimized due to compromises because only the entries of the configuration set that are directly affected by the compromised credential or association may be considered invalid. For example, if one network slice is compromised, other associations between a given device and subscriber may still be able to operate so long as they are not paired into the same tuple with the compromised network slice.

NextGen (23.861,23.864) expects to enable deployment of diverse and numerous IoT devices in addition to new upcoming personal devices that are designed to capitalize the power and flexibility of NextGen. The security provisioning in LTE/EPC is still very focused on subscriber. Appropriate data structure addressing the relation between subscriber associated with multiple devices and multiple network slices is due. The following is a pre-study from the perspective of security association. In NextGen, the relation between network slice (S) and device (D) as well as relation between device and subscriber (U) is no more unique. The security architecture has to clarify this relation to assure confidentiality, integrity and availability of the communication services. The challenge is caused by following probable requirements that a subscriber (user) may belong to different slices, a subscriber can have multiple devices, and/or a device can have multiple subscribers.

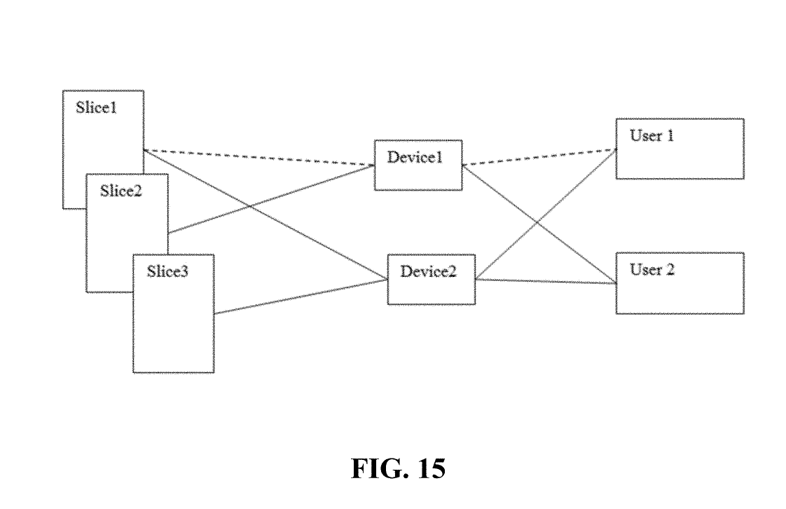

FIG. 15 shows an exemplary relationships between network, device and subscriber. As shown in FIG. 15, the mapping from slices (S) to devices as well as the mapping from devices to subscribers are not one-to-one. In order to define security procedure, security associations is important assets and need be clarified. The exemplary clarification can be made as follows:
Device can be further divided into device network (DS), i.e. the interface facing the network, so that each DS corresponds to a single slice (S).
Device can also be further divided into device users (DU), i.e. the interface facing the subscriber, so that each DU corresponds to a single subscriber (U).
Each triplet (S, D, U) defines a unique association, serving as the foundation for authentications. The set of triplets is thus a configuration parameter for a device and HSS.

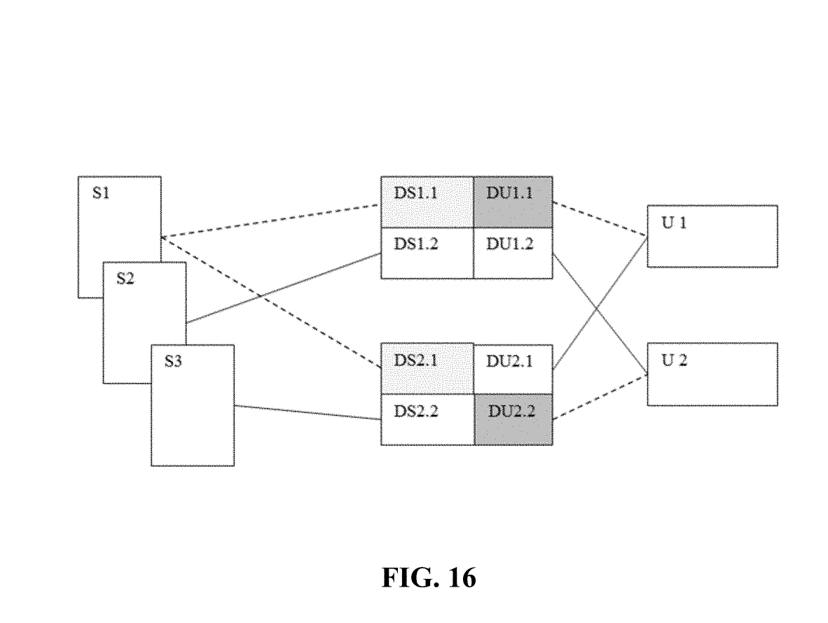

FIG. 16 shows exemplary security associations where user groups are defined by U1 and U2. There is an internal network in each device, with DS and DU as nodes, providing relation or isolation, depending on policy and subscription information. Hence, there is a cooperation between security association on device and the identity management on the network, as part of the security function in HSS. Both sides maintain two lists. The following tables show the exemplary lists for security associations.

TABLE 4
Example of list for security associations: SA (DS)

| SA | S1 | S2 | S3 | S4 |
|---|---|---|---|---|
| D1 | Sa1.1 | Sa1.2 | | |
| D2 | Sa2.1 | | Sa2.3 | |

TABLE 5
Example of list for security associations: SA (DU)

| SA | U1 | U2 | U3 | U4 |
|---|---|---|---|---|
| D1 | Sa1.1 | Sa1.2 | | |
| D2 | Sa2.1 | Sa2.2 | | |

The foundation of the data structure of security association is three dimensional cells, consisting of user (1D), device (2D), slice (3D). Each cell contains the security materials, policies and settings. As those data will be placed in the IPC (identity provision centre), the following two points need to be addressed. First, rules are defined such that the search is efficient. This is because the number of data can be up to Nu*Nd*Ns within a single trust domain, where Nu, Nd, Ns are the number of users, devices and slices, respectively. Second, each search results in unique outcome. In terms of graph theory, the relation slice: device: user are to concatenated bi-partite graphs with weighted edges. Since the mapping from slice to device and device to users are not injective, reduction of the structure is needed.

To address the second point, one of the possible approach is to introduce the term “Group” to users, so that all users that have association with a single device are identified by an additional group identifier, so that this identity is used in the primary search. After the primary search, the secondary search can resolve the ambiguity when needed. Using the group identifier, the security association path (sap) from the user group to the slice can be expressed by an expression like sap=g_i. d_j. s_k, where i, j, k are indexes. It identifies the user group g_i, the device d_j and the slice s_k. Hence, there are two security channels to be established, i.e. one between g_i and d_j, and one between d_j and s_k. Then, any search from a slice will end at a unique user group, even when sometimes through different devices. Another advantage includes the possibility of hiding the privacy of the user from attacker in some applications (e.g. by selection of authentication credentials).

To address the first point, the search begins with device, as device lies at the end of two connected security associations. This would facilitate the operation. Hence, the data cell in the data base shall be designed such that it is convenient to find slice and user group information from the plane defined by device. This may lead to possible optimization of data splits between the functional entities, because the data structure and search order may have impact on selecting the optimal approach to the security methods.

The configuration set (S, D, U) is unique for a given device. For each triplet there are two security associations, one facing network and the other facing subscriber. What lies between these two interfaces is the task of policy and service control. The security related issues to be worked out include security requirements for interfaces S-DS, DS-DU, DU-U, procedures for lifecycle management of the security associations, guidance on security policy for each (S,DS, U) in dependence of the provided services, and/or protocols and methods for security provision on each security association.

Security Monitoring and Management

Examples of security monitoring and management system/mechanism capable of handling the new infrastructure in NextGen are discussed. The infrastructure underlying NextGen is going to be highly flexible and capable, enabled by NFV and SDN. At the same time, it makes the foundation of NextGen and the therefore the network functions vulnerable to attacks from all levels of the network infrastructure. Protection of the subscriber privacy and the infrastructure safety are more and more closely related than before and ought to be taken into account together for the operation, in order to provide a secure operation environment for the operators.

Proper operation of infrastructure rely on an effective monitoring and management for the security provisioning. This becomes harder by NextGen, because of the introduction of NFV and SDN as the enabling technologies. It is well known that NFV and SDN are more vulnerable against software based security attacks without proper provisioning of security protection. What makes thing worse for NextGen is that the security breaches can impact the services of the NextGen in a devastating way, if monitoring and resilience are not provided properly. Because of the dynamic across multiple layers in the network, it is important that the monitoring and management of security status be provided across multiple layers. Such a system will have the capability to coordinate the operation of different layers of the network infrastructure and correlate the issues to the services and subscribers that are to be impaired.

Some critical applications may need to more frequent exchange of security related information between application, say slice, and NFV/SDN layers, to avoid worst scenario and to provide warning or prevention capability.

A security monitoring and management (SMM) function in this context can be divided into two parts, i.e., (1) NextGen function specific and (2) underlying infrastructure specific. The first part deals with monitoring and management of security status in CN and RN, providing resilience against risks that is intrinsic to the wireless networks. The second part deals with the underlying infrastructure such as NFV and SDN, to make sure that any security breach be localized and measures of mitigating the impact on the NextGen service be minimized.

An instance of virtualized network functions (VNF) are running software, often hosted by a cloud and, as such, is subject to dynamic changes (life cycle, load balance, resilience operation etc.). Therefore, any security related issue on this layer will impact a large amount of network elements, services and subscribers in NextGen. When the communication function of VNFs are provided by SDNized transport network, compromising a controller or a switch will have even more devastating impact on the NextGen services. Therefore, an effective security monitoring and management (SMM) of NextGen has to incorporate the lower layers to enable consistent reaction to any security events. Moreover, a deeper coordination into multiple layers in terms of security monitoring and management will also benefit quality of service including LI.

To provide a security monitoring and management, the following two requirement parts are considered.

Requirement Part 1:

1.1. Identify network function, location and entity required by NextGen for security monitoring and management.

1.2. Identify network function, location and entity required by network slicing for security monitoring and management.

1.3. Procedures of monitoring and management.

Requirement Part 2:

2.1. Security related information exchange between NextGen and the underlying NFV/SDN infrastructure.

2.2. Specify interfaces and protocols for mutual authentications and integrity protection between slices.

2.3. Specify interfaces to the underlying NFV/SDN for security related information exchange.

2.4. Specify interfaces and protocols between SMM and MANO(management and orchestration), so that the security interaction between NextGen and underlying NFV/SDN are configurable and manageable in a consistent way.

2.5. Present security performance minimal requirement on the underlay.

Recall that different roles are acting together in a NextGen network to enable service provision, including the subscriber (all information available related to subscriber, essential asset of the MNO), the device (type and applications), the security provision (user, policy, implementation, monitoring), the network provision (user priority based on subscriber info, network function and network resource) covering both core and access domain, and the Network management (configuration, assessment and resource provision and conflict resolution).

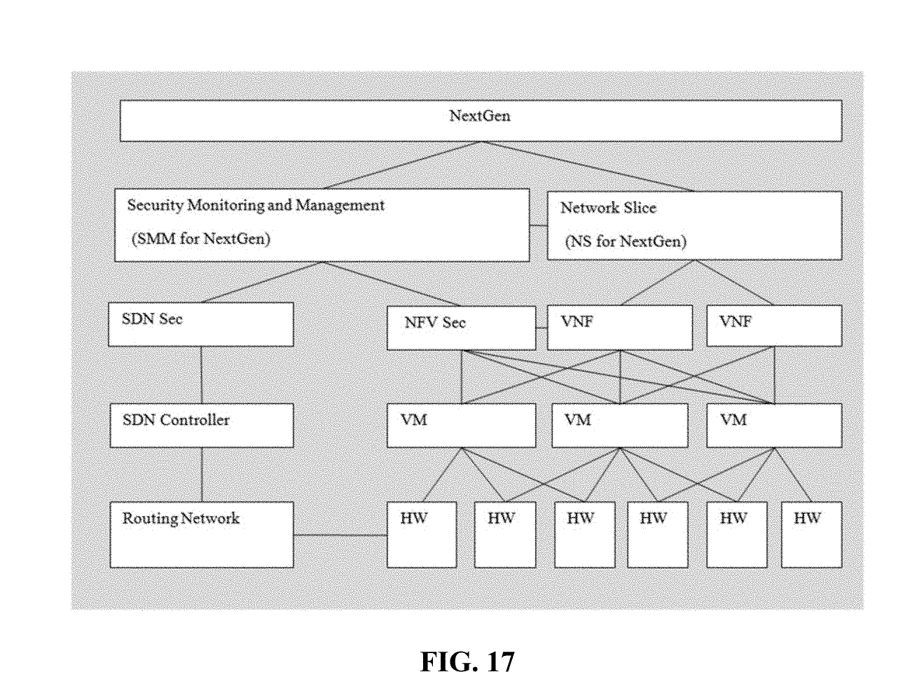

It is expected to inter-act with a core network domain, access network domain, underlying domains, for example, NFV, SDN and even bare metal equipments if necessary, and ISM(identity and slice management function in NextGen). It is capable of detecting security breach, triggering warning, enforcing prevention and restoration in conjunction with the NMS or MANO. FIG. 17 shows a logical relations between SMNI and other functions in NextGen infrastructure.

It will be appreciated that technologies, among other things, for providing security to network communication and devices in the next generation network architecture have been disclosed.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A network-side apparatus for operation in a communication network, comprising:
one or more memories storing code; and
one or more processors that read the code from the one or more memories and implement an identity and slice management (ISM) function in the communication network, the code comprising:
instructions for establishing communication with multiple network slice home subscriber servers (SHSS);
instructions for communicating with multiple subscriber devices;
instructions for establishing a communication interface with an identity center in the communication network, wherein the identity center holds information about subscriber identities and activities of the multiple network slices; and
instructions for, upon receiving a request from a new subscriber device, assigning an initial network slice to the new subscriber device.

2. The apparatus of claim 1, wherein the code further includes:
instructions for, upon receiving the request, initiating an authentication and key agreement (AKA) protocol exchange with the new subscriber device; and
providing, upon successful completion of the AKA protocol exchange, ephemeral keys and policy material to the initial network slice.

3. The apparatus of claim 1, wherein the communication interface with the identity center is a secure communication interface.

4. The apparatus of claim 1, wherein the instructions for establishing communication with multiple network slice home subscriber servers (SHSS) include instructions for establishing the communication using a management and orchestration (MAN) protocol.

5. The apparatus of claim 1, wherein the one or more processors are configured to implement an additional ISM function operating in another communication network that is different from the communication network.

6. The apparatus of claim 1, wherein the subscriber device belongs to at least two of the multiple network slices.

7. A network-side apparatus for operation in a communication network including network slices, comprising:
one or more memories storing code; and
one or more processors that read the code from the one or more memories and implement an identity and slice management (ISM) function having established communication interfaces with the network slices, the code comprising:
instructions for receiving an access request from a subscriber device;
instructions for sending a security request to an IPC (Identity Provision Center) function to fetch identity related information on the subscriber device;
instructions for receiving identity related information from the IPC; and
instructions for initiating a key agreement (AKA) protocol exchange with the subscriber device.

8. The apparatus of claim 7, wherein the code further includes instructions for obtaining information on the network slices from management and orchestration (MANO).

9. The apparatus of claim 7, wherein the code further includes instructions for establishing a communication interface between the IPC and one of the network slices.

10. The apparatus of claim 7, wherein the received identity related information includes ephemeral keys derived from one or more secondary credentials.

11. The apparatus of claim 7, wherein the subscriber device belongs to the network slices.

12. A method of providing unique identities to multiple entities in a next generation network, comprising:
maintaining a database that includes information about subscribe devices and network slices available in a communication network;
receiving, from an identity and slice management (ISM) function an identity request message comprising credential information for a subscriber device;
providing, to the ISM function, identity information for the subscriber device; and
providing, to a home subscriber server of a serving network slice for the subscriber device, information to facilitate service offering by the serving network slice to the subscriber device.

13. The method of claim 12, further including:
establishing secure communication with the ISM function.

14. The method of claim 12, further including:
providing key information to enable secure communication between the ISM function and the home subscriber server of the serving network.

15. A method of deriving a security key in a communication network including network slices, comprising:
generating an ephemeral root key using a static key and one or more secondary credentials; and
generating a plurality of subordinate keys using the ephemeral root key,
wherein at least one of the subordinate keys is used to provide services of a network slice to a subscriber device.

16. The method of claim 15, wherein the generating of the ephemeral root key includes using a AKA key derivation function.

17. The method of claim 16, wherein the reusing of AKA key derivation function is assisted by asymmetrical keys.

18. The method of claim 15, wherein the static key includes a subscriber root credential, a device root credential, a network root credential.

19. The method of claim 15, wherein the generating of the ephemeral root key includes applying a credential level such that a particular subset of credentials is generated depending on the credential level.
